(19) United States
(12) Patent Application Publication
(10) Pub. No.: US 2004/0169882 A1
(43) Pub. Date: Sep. 2, 2004

(54) Methods and apparatus for providing printing services by assigning a telephone number to a printer

(75) Inventors: Ofer Tenenbaum, San Jose, CA (US); John Armstrong, Half Moon Bay, CA (US); Brian Horner, Berkeley, CA (US)

Correspondence Address: LAW OFFICE OF BARRY R LIPSITZ, 755 MAIN STREET, MONROE, CT, 06468, US

(73) Assignee: Electronics for Imaging, Inc., Foster City, CA

(21) Appl. No.: 10/785,315

(22) Filed: Feb. 23, 2004

Related U.S. Application Data
(60) Provisional application No. 60/450,654, filed on Feb. 28, 2003.

(51) Int. Cl. G06F 15/00; H04N 1/00

(52) U.S. Cl. 358/1.15; 358/440

(57) ABSTRACT

The present invention provides methods and systems for providing printing services. In particular, the present invention enables a print job source, for example a facsimile machine, to print directly to a printer over a network, without an intervening personal computer. In an example embodiment of the invention, a telephone number is assigned to a printer. A print job is associated with the telephone number. The print job is then forwarded from a print job source to a spooling server over a network. The print job is associated with the printer at the spooling server based on the telephone number. The print job is then forwarded from the spooling server to the printer and printed.

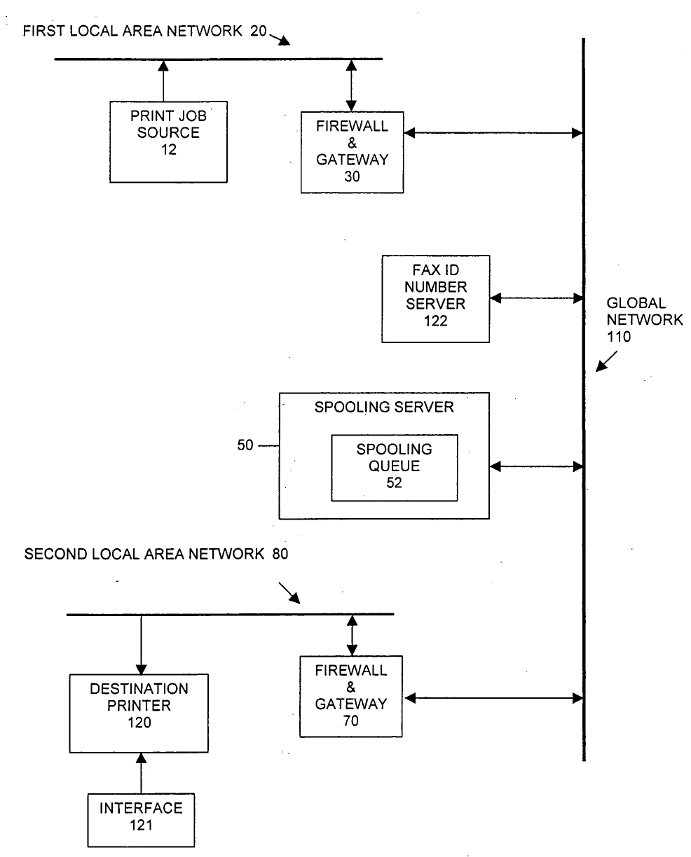

This application claims the benefit of U.S. provisional patent application No. 60/450,654 filed on Feb. 28, 2003, which is incorporated herein and made a part hereof by reference.

### BACKGROUND OF THE INVENTION

The present invention relates provides methods and systems for providing printing services. In particular, the present invention enables a print job source, for example a facsimile machine or a multifunction print device, to print directly to a printer over a network, without an intervening personal computer.

Currently, documents sent via a facsimile machine or a multifunction print device must be received at another facsimile machine or similar device over an analog communication channel, such as a standard telephone line. Alternatively, a document sent from a facsimile machine (or similar device) may be received a personal computer equipped with a fax card over an analog communication channel. The document can then be printed from the personal computer at an associated printer.

It would be advantageous to enable a document to be sent via a facsimile machine over a network directly to a printer, without a computer between the facsimile machine and the printing device. It would be further advantageous to assign a unique identification number to the printer, such as a telephone number, to enable direct communication between the facsimile machine and the printer.

The methods and systems of the present invention provide the foregoing and other advantages.

### SUMMARY OF THE INVENTION

The present invention provides methods and systems for providing printing services. In particular, the present invention enables a print job source, for example a facsimile machine or a multifunction print device, to print directly to a printer, without an intervening personal computer. In an example embodiment of the invention, a telephone number is assigned to a printer. A print job is associated with the telephone number. The print job is then forwarded from a print job source to a spooling server over a network. The print job is associated with the printer at the spooling server based on the telephone number. The print job is then forwarded from the spooling server to the printer and printed.

### BRIEF DESCRIPTION OF THE DRAWINGS

The FIGURE shows a block diagram of an example implementation of the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

The present invention provides methods and systems for providing printing services. In particular, the present invention enables a print job source, for example a facsimile machine, to print directly to a printer over a network, without an intervening personal computer. In an example embodiment of the invention as shown in the FIGURE, a telephone number is assigned to a printer 120. A print job (e.g., from a print job source 12) is associated with the telephone number. The print job is then forwarded from the print job source 12 to a spooling server 50 over a network 110. The print job is associated with the printer 120 at the spooling server 50 based on the telephone number. The print job is then forwarded from the spooling server 50 to the printer 120 and printed.

It should be appreciated that printer 120 may be one of a plurality of printers connected to the spooling server 50 via the network 110. Each printer in the network may have a unique telephone number assigned to it. A single printer is shown in the FIGURE for ease of explanation.

The print job source 12 may comprise a facsimile machine or a multifunction print device. In such an embodiment, the telephone number (or other type of multifunction device ID) may be associated with the print job by entering the telephone number (or multifunction device ID) at the facsimile machine or the multifunction print device.

The print job source 12 may also comprise one of a computer, a personal digital assistant device, an Internet appliance, a scanner, a telephone, or the like.

The network 110 may comprise at least one of a local area network, a wide area network, a global network, the Internet, or the like. The network 110 may comprise a combination of various types of interconnected networks. As an example, the FIGURE shows the print job source 12 within a first local area network 20, which is in communication with a global area network 110 via a firewall and gateway 30. The printer 120 is within a second local area network 80, which is in communication with the global area network 110 via a firewall and gateway 70. The spooling server 50 may be outside of the local area networks 20, 80. Those skilled in the art should appreciate that the FIGURE shows an example arrangement, and that the invention may be implemented using a single network or various combinations of different types of networks.

Where the print job comprises a facsimile, the Network 110 may comprise the Internet. Such an embodiment enables facsimiles to be sent directly to a printer 120 without incurring traditional telephone charges incurred when using a traditional Public Switched Telephone Network.

The printer 120 may be connected directly to the network 110 via a dedicated Internet connection.

A facsimile server 122 may assign the telephone number to the printer 120. The facsimile server 122 hosting the telephone number may be any device with the ability to route facsimile transmissions to the Internet. The facsimile server 122 may receive the print job (e.g., a facsimile) from the print job source 12 (e.g., a facsimile machine) via the network 110. Using one of a variety of transports, including, but not limited to, Simple Mail Transport Protocol (SMTP), Simple Object Access Protocol (SOAP), Extensible Markup Language (XML), Hypertext Transfer Protocol (HTTP), Hypertext Transfer Protocol Secure (HTTPS), or the like, the facsimile server 122 will transmit the received facsimile to the spooling server 50 where it will reside as a print job, identifying the transmission by the telephone number it was received on. The spooling server 50 will then associate the transmission with the printing device 120 based on the telephone number.

In a further example embodiment, the print job may be stored on the spooling server 50 (e.g., in spooling queue 52) based on said telephone number, and the telephone number may be dynamically assigned to the printer by a user (e.g., at user interface 121). In other words, where the telephone number is dynamically associated with the printer 120, there is no direct pre-association between the telephone number and the printer 120 at the time the print job is sent to the spooling server 50. Once the print job is sent and stored on the spooling server 50, the user can type in the telephone number at any printer 120 equipped with an appropriate user interface 121 and obtain the print job associated with that telephone number from the spooling server 50.

In a further example embodiment, the print job may originate with a multifunction print device and be delivered to the spooling server 50 over the network 110 for delivery to any print device 120 that is equipped with an appropriate user interface 121. In other words, the print job source 12 does not need to be a facsimile machine, print driver, PDA or other personal computing device, it can be scanned directly on the multifunctional print device and directed over the network 110 to the spooling server 50 for later output.

It will now be appreciated that the present invention provides improved methods and systems for providing printing services over a communications network. In particular, the present invention enables a print job source, for example a facsimile machine or a multifunction device, to print directly to a printer, by assigning an ID, such as a telephone number, to the printer.

Although the invention has been described in connection with preferred embodiments thereof, those skilled in the art will appreciate that numerous adaptations and modifications may be made thereto without departing from the spirit and scope of the invention, as set forth in the following claims.

What is claimed is:

1. A method for providing printing services, comprising:
assigning a telephone number to a printer;
associating a print job with said telephone number;
forwarding said print job from a print job source to a spooling server over a network;
associating the print job with the printer at the spooling server based on said telephone number;
forwarding the print job from the spooling server to the printer; and
printing said print job at said printer.

2. A method in accordance with claim 1, wherein:
said print job source comprises a facsimile machine; and
the telephone number is associated with the print job by entering the telephone number at the facsimile machine.

3. A method in accordance with claim 1, wherein the print job source is one of a computer, a personal digital assistant device, a multifunction print device, an Internet appliance, a scanner, or a telephone.

4. A method in accordance with claim 1, wherein the network comprises:
at least one of a local area network, a wide area network, a global network, and the Internet.

5. A method in accordance with claim 1, wherein:
said print job source comprises a facsimile machine;
said print job comprises a facsimile; and
said network comprises the Internet.

6. A method in accordance with claim 5, further comprising:
receiving the facsimile from the facsimile machine at a facsimile server via the network;
assigning the telephone number to the printer at the facsimile server; and
forwarding the facsimile to the spooling server from the facsimile server.

7. A method in accordance with claim 6, wherein:
said facsimile server forwards the facsimile to the spooling server using one of Simple Mail Transport Protocol, Simple Object Access Protocol, Extensible Markup Language, Hypertext Transfer Protocol, or Hypertext Transfer Protocol Secure.

8. A method in accordance with claim 1, wherein the printer is connected to the network via a dedicated Internet connection.

9. A method in accordance with claim 1, wherein:
said print job is stored at said spooling server based on said telephone number;
said telephone number is dynamically assigned to the printer at a user interface associated with said printer; and
said printer requests said print job from said spooling server based on the assigned telephone number.

10. A system for providing printing services, comprising:
a printer having a telephone number assigned thereto;
a print job source for generating a print job and associating the print job with the telephone number; and
a spooling server capable of (i) receiving the print jobs from the print job source via a network; (ii) associating the print job with the printer based on said telephone number; and (iii) forwarding the print job to the printer for printing.

11. A system in accordance with claim 10, wherein:
said print job source comprises a facsimile machine; and
the telephone number is associated with the print job by entering the telephone number at the facsimile machine.

12. A system in accordance with claim 10, wherein the print job source is one of a computer, a personal digital assistant device, a multifunction print device, an Internet appliance, a scanner, or telephone.

13. A system in accordance with claim 10, wherein the network comprises:
at least one of a local area network, a wide area network, a global network, and the Internet.

14. A system in accordance with claim 10, wherein:
said print job source comprises a facsimile machine;
said print job comprises a facsimile; and
said network comprises the Internet.

15. A system in accordance with claim 14, further comprising:
a facsimile server for:
receiving the facsimile from the facsimile machine via the network;
assigning the telephone number to the printer; and
forwarding the facsimile to the spooling server.

16. A system in accordance with claim 15, wherein:
said facsimile server forwards the facsimile to the spooling server using one of Simple Mail Transport Protocol, Simple Object Access Protocol, Extensible Markup Language, Hypertext Transfer Protocol, or Hypertext Transfer Protocol Secure.

17. A system in accordance with claim 10, wherein the printer is connected to the network via a dedicated Internet connection.

18. A system in accordance with claim 10, wherein:
said print job is stored at said spooling server based on said telephone number;
said telephone number is dynamically assigned to the printer at a user interface associated with said printer; and
said printer requests said print job from said spooling server based on the assigned telephone number.
